(19) United States
(12) Patent Application Publication
(10) Pub. No.: US 2026/0181593 A1
(43) Pub. Date: Jun. 25, 2026

(54) METHODS OF NR THROUGHPUT IMPROVEMENT VIA ADAPTIVE LTE CONTROL FORMAT INDICATOR (CFI) DETERMINATION IN DYNAMIC SPECTRUM SHARING

(71) Applicant: Telefonaktiebolaget LM Ericsson (publ), Stockholm (SE)

(72) Inventor: Ho Ting CHENG, Stittsville (CA)

(73) Assignee: Telefonaktiebolaget LM Ericsson (publ), Stockholm (SE)

(21) Appl. No.: 19/121,424

(22) PCT Filed: Nov. 15, 2022
(86) PCT No.: PCT/IB2022/060996

§ 371 Date: Apr. 15, 2025

(51) Int. Cl. H04W 72/02; H04W 88/06

(52) U.S. Cl. CPC H04W 72/02; H04W 88/06

(57) ABSTRACT

A method, system and apparatus are disclosed. A network node configured for dynamic spectrum sharing of a first RAT and a second RAT is provided. The network node is configured to determine a first number of failed scheduling requests associated with the first RAT, determine a resource configuration for the first RAT and the second RAT for a first time period based on the first number of failed scheduling requests, and schedule at least one transmission for the first time period with at least one wireless device based on the resource configuration.

### TECHNICAL FIELD

The present disclosure relates to wireless communications, and in particular, to adaptive control format indicator (CFI) determination in dynamic spectrum sharing.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between wireless devices. 3GPP is also working on Sixth Generation (6G) wireless communication systems.

### Spectrum Sharing

Existing 5G systems may include both new and legacy spectrum bands. This may require functionality that enables operators to plan evolution of network assets including both new and legacy spectrum bands and technologies, as well as to allow for a seamless roll-out of 5G with optimal end-user performance. A Dynamic Spectrum Sharing (DSS) solution may allow for intelligently, flexibly, and quickly introducing and adding 5G within existing 4G carriers, such as by introducing 5G on low/mid bands for wide area coverage and outside in coverage. DSS software may dynamically share spectrum between, e.g., 4G and 5G carriers based on traffic demand. The switch between carriers may occur within milliseconds, for example, which may minimize spectrum wastage and allows for best end-user performance.

In some existing systems for dynamic spectrum sharing, an arbitrator (i.e., a unit or module implemented in computer/radio software and/or hardware) is employed which decides how radio resources may be allocated to LTE and NR per timeslot.

For example, one existing sharing algorithm considers two orthogonal frequency-division multiplexing (OFDM) symbols for LTE Physical Downlink Control Channel (PDCCH), one OFDM symbol for NR PDCCH, and eleven OFDM symbols for NR Physical Downlink Shared Channel (PDSCH), if NR traffic is transmitted over the air.

NR throughput improvement in DSS cells is a desired feature of such systems. One way to improve NR throughput performance is to increase the number of OFDM symbols for NR PDSCH at the expense of LTE PDCCH symbols.

For instance, this may include setting one OFDM symbol for LTE PDCCH, one OFDM symbol for NR PDCCH, and twelve OFDM symbols for NR PDSCH via the configuration of a LTE Control Format Indicator (CFI) Max parameter in dynamic spectrum sharing. For example:
If LTE CFI Max is 3, the LTE CFI value (e.g., determined by an LTE scheduler) may be 3, 2, 1 or 0.
If LTE CFI Max is 2, the LTE CFI can be 2, 1 or 0.
If LTE CFI Max is 1, the LTE CFI can be 1 or 0.

However, such a static allocation approach as used in existing systems may be undesirable because the LTE PDCCH capacity may be reduced statically, which could potentially degrade the performance of high-priority traffic bands.

For example, existing systems may allow only a fixed number of OFDM symbols allocated to NR PDSCH. A static LTE CFI Max=1 approach may increase NR throughput performance by allowing NR to use one more OFDM symbol at the expense of LTE PDCCH capacity, while potentially degrading the performance of high-priority LTE traffic bands.

The following examples illustrate drawbacks of existing systems.

In a first example, described in Table 1 below, utilizing one more ODFM symbol statically in NR PDSCH in dynamic spectrum sharing increases NR throughput by 13.3% (from 75.8 Mb/s to 85.9 Mb/s).

TABLE 1
Example 1

| Baseline/LTE CFI Max = 2 | Static LTE CFI Max = 1 |
|---|---|
| OFDM Grid | OFDM Grid |
| Symbols {0, 1}: LTE | Symbol 0: LTE PDCCH |
| PDCCH | Symbol 2: NR PDCCH |
| Symbol 2: NR PDCCH | Symbols {1, 3, 4, . . . , 13}: |
| Symbols {3, 4, . . . , 13}: | NR PDSCH |
| NR PDSCH | NR DL Throughput |
| NR Downlink (DL) Throughput | 85.9 Mb/s |
| 75.8 Mb/s | |

In a second example, described in Table 2 below, sacrificing one ODFM symbol statically in LTE PDCCH (for NR PDSCH) results in a large increase in the percentage of failed LTE scheduling requests.

TABLE 2
Example 2

| Baseline/LTE CFI Max = 2 | Static LTE CFI Max = 1 |
|---|---|
| OFDM Grid | OFDM Grid |
| Symbols {0, 1}: LTE | Symbol 0: LTE PDCCH |
| PDCCH | Symbol 2: NR PDCCH |
| Symbol 2: NR PDCCH | Symbols {1, 3, 4, . . . , 13}: |
| Symbols {3, 4, . . . , 13}: | NR PDSCH |
| NR PDSCH | Percentage of Failed High- |
| Percentage of Failed High- | Priority LTE Scheduling |
| Priority LTE Scheduling | Requests |
| Requests | 50% |
| 0% | |

Thus, existing systems may fail to adequately balance NR throughput improvement with the performance of high-priority LTE traffic.

### SUMMARY

Adaptive LTE CFI Max determination in dynamic spectrum sharing may be advantageous, leading to NR throughput improvement without degrading the performance of high-priority LTE traffic bands in dynamic spectrum sharing.

Some embodiments of the present disclosure implement an adaptive LTE CFI Max determination algorithm and method including at least three system/method block elements: a Cost function, a determination of LTE CFI Max parameter options, and an LTE CFI Max parameter option selection algorithm. The algorithm considers the performance of high-priority LTE scheduling requests dynamically and actively looks at opportunities to improve NR throughput, e.g., by setting LTE CFI Max to 1.

In some embodiments, the overall system architecture is based on existing DSS system architectures, where an arbitrator outputs and informs an LTE scheduling module/unit (e.g., implemented in software and/or processing circuitry hardware) and an NR scheduling unit ((e.g., implemented in software and/or processing circuitry hardware) based on the LTE CFI Max value, where embodiments of the present disclosure include an adaptive LTE CFI Max determination methodology inside the arbitrator, rather than the static determination used in some existing systems.

Embodiments of the present disclosure may adaptively determine an LTE CFI Max value which improves NR throughput performance without sacrificing the performance of high-priority LTE scheduling requests. For example, some embodiments may be able to adapt to time-varying traffic characteristics and hence perform better than some existing systems in which a static LTE CFI Max approach is utilized.

For example, an adaptive LTE CFI Max determination algorithm according to some embodiments of the present disclosure can improve NR throughput performance without degrading the performance of high-priority LTE scheduling requests, leading to an improved performance tradeoff between the two key performance indicators, as described in Example 3 in Table 3 below.

TABLE 3
Example 3 (Full Buffer Traffic with
50% High Priority LTE Traffic Bands)

| Baseline/LTE | Static LTE | |
|---|---|---|
| CFI Max = 2 | CFI Max = 1 | Adaptive Algorithm |
| OFDM Grid | OFDM Grid | OFDM Grid |
| Symbols {0, | Symbol 0: | Symbols {0} or {0, 1}: |
| 1}: LTE | LTE PDCCH | LTE PDCCH |
| PDCCH | Symbol 2: | Symbol 2: NR |
| Symbol 2: | NR PDCCH | PDCCH |
| NR PDCCH | Symbols | Symbols |
| Symbols | {1, 3, 4, . . . , 13}: | {1, 3, 4, . . . , 13}: or |
| {3, 4, . . . , 13}: | NR PDSCH | {3, 4, . . . , 13} NR |
| NR PDSCH | NR DL Throughput | PDSCH |
| NR DL Throughput | 85.9 Mb/s | NR DL |
| 75.8 Mb/s | Percentage of Failed | Throughput ~80.9 Mb/s |
| Percentage of | High-Priority LTE | Percentage of Failed |
| Failed High- | Scheduling Requests | High-Priority LTE |
| Priority LTE | 50% | Scheduling |
| Scheduling | | Requests ~0% |
| Requests | | |
| 0% | | |

Some embodiments advantageously provide methods, systems, and apparatuses for adaptive CFI determination in dynamic spectrum sharing.

For example, some embodiments provide an LTE CFI Max determination method to improve NR throughput performance without degrading the performance of high-priority LTE scheduling requests.

In some embodiments, the LTE CFI Max determination method includes 1) a cost evaluation, 2) a LTE CFI Max parameter option configuration, and 3) a LTE CFI Max parameter selection algorithm.

In some embodiments, the cost function that evaluates the performance of high-priority LTE traffic may be an exponentially weighted average of the number of failed LTE scheduling requests.

In some embodiments, the weighting factors used in cost evaluation may be updated based on time-varying traffic characteristics.

The LTE CFI Max selection algorithm that selects a set of LTE CFI Max values may be based on a user-defined threshold, the rate of improvement in cost, etc.

According to a first aspect of the present disclosure, a network node configured for dynamic spectrum sharing of a first RAT and a second RAT is provided. The network node is configured to determine a first number of failed scheduling requests associated with the first RAT, to determine a resource configuration for the first RAT and the second RAT for a first time period based on the first number of failed scheduling requests, and, optionally, to schedule at least one transmission for the first time period with at least one wireless device based on the resource configuration.

According to one or more embodiments of this aspect, the determining of the resource configuration for the first RAT and the second RAT for the first time period is further based on first RAT traffic demands and second RAT traffic demands. According to one or more embodiments of this aspect, the determining of the resource configuration for the first RAT and the second RAT for the first time period includes computing a cost function, where the cost function is computed based on at least one of the first number of failed scheduling requests associated with the first RAT, at least one weighting factor associated with at least one corresponding failed scheduled request of the first number of failed scheduling requests associated with the first RAT, and a previous computed cost associated with a previous time period prior to the first time period. According to one or more embodiments of this aspect, the at least one weighting factor is determined based on at least one of an amount of elapsed time since the at least one corresponding failed scheduling request occurred, traffic characteristics associated with at least one of the first RAT and the second RAT, a priority associated with the at least one corresponding failed scheduling request, a burstiness characteristic of the at least one corresponding failed scheduling request, and a stability value associated with the at least one corresponding failed scheduling request.

According to one or more embodiments of this aspect, the resource configuration is selected from a set of available resource configurations, and the set of available resource configurations is determined based on whether the output of the cost function is above a threshold value. According to one or more embodiments of this aspect, the threshold value is determined based on traffic characteristics associated with at least one of the first RAT and the second RAT. According to one or more embodiments of this aspect, the network node is further configured to update the at least one weighting factor for computing the cost function for a subsequent time period to the first time period. According to one or more embodiments of this aspect, the resource configuration corresponds to at least one of a control format indicator, CFI, Max configuration, and a symbol configuration. According to one or more embodiments of this aspect, the network node is a distributed unit, DU, configured to communicate with a radio unit in communication with the at least one wireless device, the scheduling of the at least one transmission for the first time period including configuring the radio unit with the CFI Max configuration. According to one or more embodiments of this aspect, the first RAT is a legacy RAT, and the second RAT is a non-legacy RAT.

According to another aspect of the present disclosure, a method implemented in a network node is provided. A first number of failed scheduling requests associated with a first RAT is determined. A resource configuration for the first RAT and the second RAT for a first time period is determined based on the first number of failed scheduling requests. At least one transmission for the first time period with at least one wireless device is scheduled based on the resource configuration.

According to one or more embodiments of this aspect, the determining of the resource configuration for the first RAT and the second RAT for the first time period is further based on first RAT traffic demands and second RAT traffic demands. According to one or more embodiments of this aspect, the determining of the resource configuration for the first RAT and the second RAT for the first time period includes computing a cost function, where the cost function is computed based on at least one of the first number of failed scheduling requests associated with the first RAT, at least one weighting factor associated with at least one corresponding failed scheduled request of the first number of failed scheduling requests associated with the first RAT, and a previous computed cost associated with a previous time period prior to the first time period. According to one or more embodiments of this aspect, the at least one weighting factor is determined based on at least one of an amount of elapsed time since the at least one corresponding failed scheduling request occurred, traffic characteristics associated with at least one of the first RAT and the second RAT, a priority associated with the at least one corresponding failed scheduling request, a burstiness characteristic of the at least one corresponding failed scheduling request, and a stability value associated with the at least one corresponding failed scheduling request.

According to one or more embodiments of this aspect, the resource configuration is selected from a set of available resource configurations, and the set of available resource configurations is determined based on whether the output of the cost function is above a threshold value. According to one or more embodiments of this aspect, the threshold value is determined based on traffic characteristics associated with at least one of the first RAT and the second RAT. According to one or more embodiments of this aspect, the method further includes updating the at least one weighting factor for computing the cost function for a subsequent time period to the first time period. According to one or more embodiments of this aspect, the resource configuration corresponds to at least one of a control format indicator, CFI, Max configuration, and a symbol configuration. According to one or more embodiments of this aspect, the network node is a distributed unit, DU, configured to communicate with a radio unit in communication with the at least one wireless device, the scheduling of the at least one transmission for the first time period including configuring the radio unit with the CFI Max configuration. According to one or more embodiments of this aspect, the first RAT is a legacy RAT, and the second RAT is a non-legacy RAT.

According to another aspect of the present disclosure, an orchestrator node configured for dynamic spectrum sharing of a first RAT and a second RAT is provided. The orchestrator node is configured to determine a first number of failed scheduling requests associated with the first RAT, determine a resource configuration for the first RAT and the second RAT for a first time period based on the first number of failed scheduling requests, and cause transmission of the resource configuration to a network node for scheduling at least one transmission for the first time period with at least one wireless device based on the resource configuration.

According to one or more embodiments of this aspect, the determining of the resource configuration for the first RAT and the second RAT for the first time period is further based on first RAT traffic demands and second RAT traffic demands. According to one or more embodiments of this aspect, the determining of the resource configuration for the first RAT and the second RAT for the first time period includes computing a cost function, where the cost function is computed based on at least one of the first number of failed scheduling requests associated with the first RAT, at least one weighting factor associated with at least one corresponding failed scheduled request of the first number of failed scheduling requests associated with the first RAT, and a previous computed cost associated with a previous time period prior to the first time period. According to one or more embodiments of this aspect, the at least one weighting factor is determined based on at least one of an amount of elapsed time since the at least one corresponding failed scheduling request occurred, traffic characteristics associated with at least one of the first RAT and the second RAT, a priority associated with the at least one corresponding failed scheduling request, a burstiness characteristic of the at least one corresponding failed scheduling request, and a stability value associated with the at least one corresponding failed scheduling request.

According to one or more embodiments of this aspect, the resource configuration is selected from a set of available resource configurations, and the set of available resource configurations is determined based on whether the output of the cost function is above a threshold value. According to one or more embodiments of this aspect, the threshold value is determined based on traffic characteristics associated with at least one of the first RAT and the second RAT. According to one or more embodiments of this aspect, the orchestrator node is further configured to update the at least one weighting factor for computing the cost function for a subsequent time period to the first time period. According to one or more embodiments of this aspect, the resource configuration corresponds to at least one of a control format indicator, CFI, Max configuration, and a symbol configuration. According to one or more embodiments of this aspect, the network node is a distributed unit, DU, configured to communicate with a radio unit in communication with the at least one wireless device, the scheduling of the at least one transmission for the first time period including configuring the radio unit with the CFI Max configuration. According to one or more embodiments of this aspect, the first RAT is a legacy RAT, where the second RAT is a non-legacy RAT.

According to another aspect of the present disclosure, a method implemented in an orchestrator node configured for dynamic spectrum sharing of a first RAT and a second RAT is provided. A first number of failed scheduling requests associated with the first RAT is determined. A resource configuration for the first RAT and the second RAT is determined for a first time period based on the first number of failed scheduling requests. The resource configuration is transmitted to a network node for scheduling at least one transmission for the first time period with at least one wireless device based on the resource configuration.

According to one or more embodiments of this aspect, the determining of the resource configuration for the first RAT and the second RAT for the first time period is further based on first RAT traffic demands and second RAT traffic demands. According to one or more embodiments of this aspect, the determining of the resource configuration for the first RAT and the second RAT for the first time period includes computing a cost function, where the cost function is computed based on at least one of the first number of failed scheduling requests associated with the first RAT, at least one weighting factor associated with at least one corresponding failed scheduled request of the first number of failed scheduling requests associated with the first RAT, and a previous computed cost associated with a previous time period prior to the first time period. According to one or more embodiments of this aspect, the at least one weighting factor is determined based on at least one of an amount of elapsed time since the at least one corresponding failed scheduling request occurred, traffic characteristics associated with at least one of the first RAT and the second RAT, a priority associated with the at least one corresponding failed scheduling request, a burstiness characteristic of the at least one corresponding failed scheduling request, and a stability value associated with the at least one corresponding failed scheduling request.

According to one or more embodiments of this aspect, the resource configuration is selected from a set of available resource configurations, and the set of available resource configurations is determined based on whether the output of the cost function is above a threshold value. According to one or more embodiments of this aspect, the threshold value is determined based on traffic characteristics associated with at least one of the first RAT and the second RAT. According to one or more embodiments of this aspect, the method further includes updating the at least one weighting factor for computing the cost function for a subsequent time period to the first time period. According to one or more embodiments of this aspect, the resource configuration corresponds to at least one of a control format indicator, CFI, Max configuration, and a symbol configuration. According to one or more embodiments of this aspect, the network node is a distributed unit, DU, configured to communicate with a radio unit in communication with the at least one wireless device, the scheduling of the at least one transmission for the first time period including configuring the radio unit with the CFI Max configuration. According to one or more embodiments of this aspect, the first RAT is a legacy RAT, and the second RAT is a non-legacy RAT.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for adaptive CFI determination in dynamic spectrum sharing according to some embodiments of the present disclosure;

FIG. 8 is a flowchart of an example process in an orchestrator node for adaptive CFI determination in dynamic spectrum sharing according to some embodiments of the present disclosure;

FIG. 9 is a block diagram and timing diagram which depicts an example adaptive CFI determination in dynamic spectrum sharing according to some embodiments of the present disclosure;

FIG. 10 is a block diagram which depicts an example arbitrator algorithm according to some embodiments of the present disclosure;

FIG. 11 is a timing diagram which depicts an example arbitrator algorithm output over time according to some embodiments of the present disclosure;

FIG. 12 is another timing diagram which depicts another example arbitrator algorithm output over time according to some embodiments of the present disclosure;

FIG. 13 is a flowchart which depicts an example adaptive CFI determination in dynamic spectrum sharing according to some embodiments of the present disclosure;

FIG. 14 is a schematic diagram which depicts an example communication link between a DSS Cell and a Cloud-based Computation Module; and

FIG. 15 is a schematic diagram which depicts an example O-RAN architecture for adaptive CFI determination in dynamic spectrum sharing according to some embodiments of the present disclosure.

### DETAILED DESCRIPTION

Before describing in detail example embodiments, it is noted that the embodiments reside primarily in combinations of apparatus components and processing steps related to adaptive CFI determination in dynamic spectrum sharing. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

In some embodiments, the terms central (or centralized) unit (e.g., CU or gNB-CU) and distributed (or decentralized) units (e.g., DU or gNB-DU) may be used. CUs (e.g., gNB-CU) may refer to logical nodes that host higher-layer protocols and perform various gNB functions such controlling the operation of DUs. Each DU may be a logical node that hosts lower-layer protocols and can include, depending on the functional split, various subsets of the gNB functions. As such, each of the CUs and DUs can include various circuitry needed to perform their respective functions, including processing circuitry, transceiver circuitry (e.g., for communication), and power supply circuitry. Moreover, the terms “central unit” and “centralized unit” are used interchangeably herein, as are the terms “distributed unit” and “decentralized unit.” A network node may refer to one or more radio units, DUs, CUs, gNB-DUs, and/or gNB-CUs, etc.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide adaptive CFI determination in dynamic spectrum sharing.

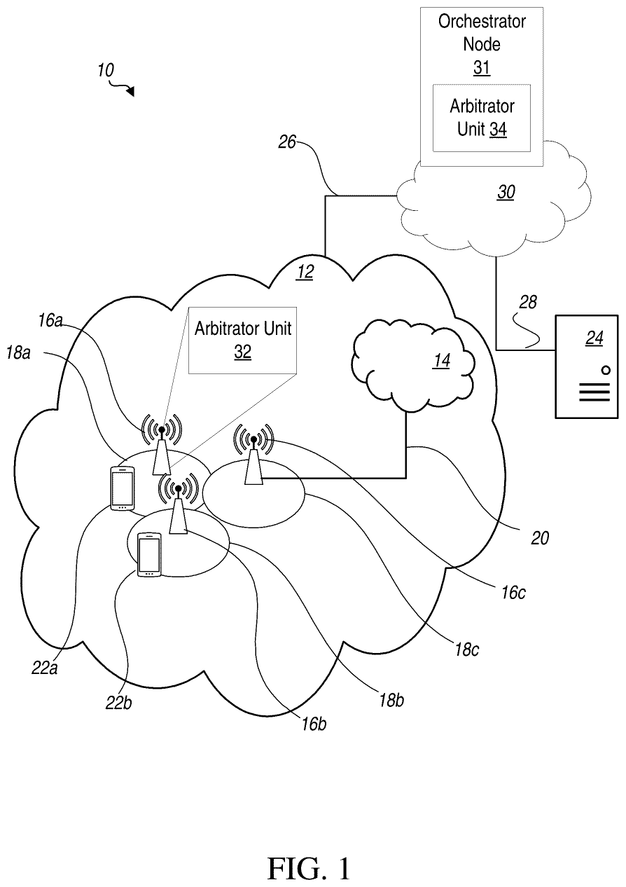

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

The communication system of FIG. 1 further includes and/or is in communication with an orchestrator node 31, which may be any cloud-based node, cloud-based computation module, virtual network node, cloud-based server, etc., which is any node/computer/server/module/unit/etc, which is configured for directing/configuring/controlling/orchestrating/modifying/monitoring/etc. one or more characteristics/settings/parameters/configurations/etc. of wireless communication network 10. Orchestrator node 31 may be part of and/or may be connected to one or more elements of wireless communication system 10 (e.g., network node 16, WD 22, core network 14, etc.), e.g., via intermediate network 30, connection 26, and/or connection 28.

A network node 16 is configured to include a Network Node Arbitrator unit 32 which is configured for adaptive CFI determination in dynamic spectrum sharing. An orchestrator node 31 is configured to include an Orchestrator Arbitrator unit 34 which is configured for adaptive CFI determination in dynamic spectrum sharing.

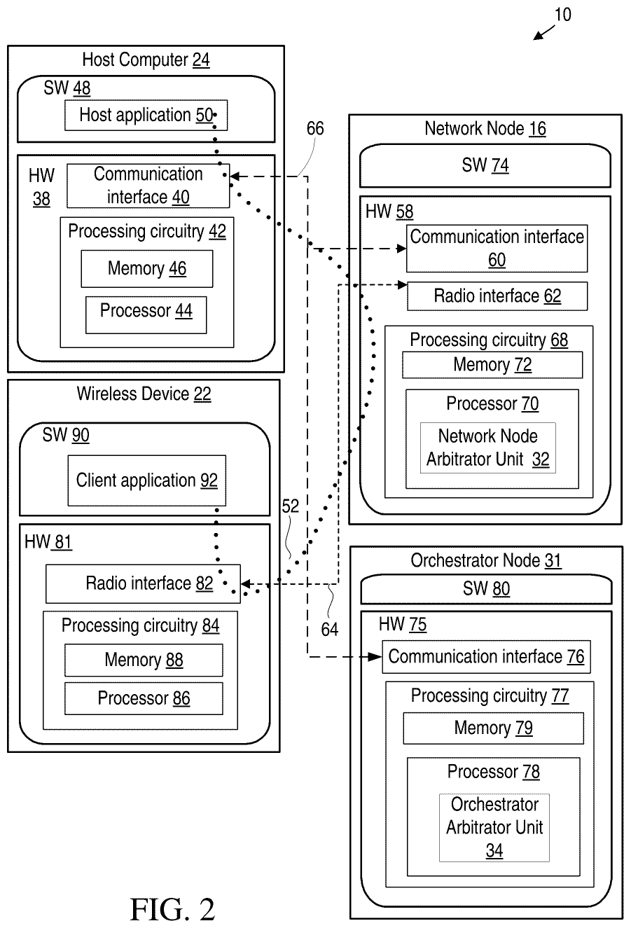

Example implementations, in accordance with an embodiment, of the WD 22, network node 16, host computer 24, and orchestrator node 31 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16, orchestrator node 31, and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24 and/or orchestrator node 31. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include Network Node Arbitrator unit 32 configured for adaptive CFI determination in dynamic spectrum sharing.

The communication system 10 further includes (and/or is in communication with) an orchestrator node 31, which includes hardware 75 enabling it to communicate with the host computer 24, the network node 16, and/or with the WD 22. The hardware 75 may include a communication interface 76 for setting up and maintaining a wired or wireless connection with an interface of a different communication device of the communication system 10. The communication interface 76 may be configured to facilitate a connection 66 to the host computer 24, network node 16, and/or WD 22. The connection 66 may be direct or it may pass through a core network 14 of the communication system 10 and/or through one or more intermediate networks 30 outside the communication system 10.

In the embodiment shown, the hardware 75 of the orchestrator node 31 further includes processing circuitry 77. The processing circuitry 77 may include a processor 78 and a memory 79. In particular, in addition to or instead of a processor, such as a central processing unit, and memory, the processing circuitry 77 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 78 may be configured to access (e.g., write to and/or read from) the memory 79, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the orchestrator node 31 further has software 80 stored internally in, for example, memory 79, or stored in external memory (e.g., database, storage array, network storage device, etc.) accessible by the orchestrator node 31 via an external connection. The software 80 may be executable by the processing circuitry 77. The processing circuitry 77 may be configured to control any of the methods and/or processes described herein and/or to cause such methods, and/or processes to be performed, e.g., by orchestrator node 31. Processor 78 corresponds to one or more processors 78 for performing orchestrator node 31 functions described herein. The memory 79 is configured to store data, programmatic software code and/or other information described herein. In some embodiments, the software 80 may include instructions that, when executed by the processor 78 and/or processing circuitry 77, causes the processor 78 and/or processing circuitry 77 to perform the processes described herein with respect to orchestrator node 31. For example, processing circuitry 77 of the orchestrator node 31 may include Orchestrator Arbitrator unit 34 configured for adaptive CFI determination in dynamic spectrum sharing.

The communication system 10 further includes the WD 22 already referred to. The WD 22 may have hardware 81 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 81 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as Network Node Arbitrator unit 32, and Orchestrator Arbitrator unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry. Further, the Network Node Arbitrator unit 32 and/or the Orchestrator Arbitrator unit 34 may be distributed across multiple network nodes 16 and/or orchestrator nodes 31.

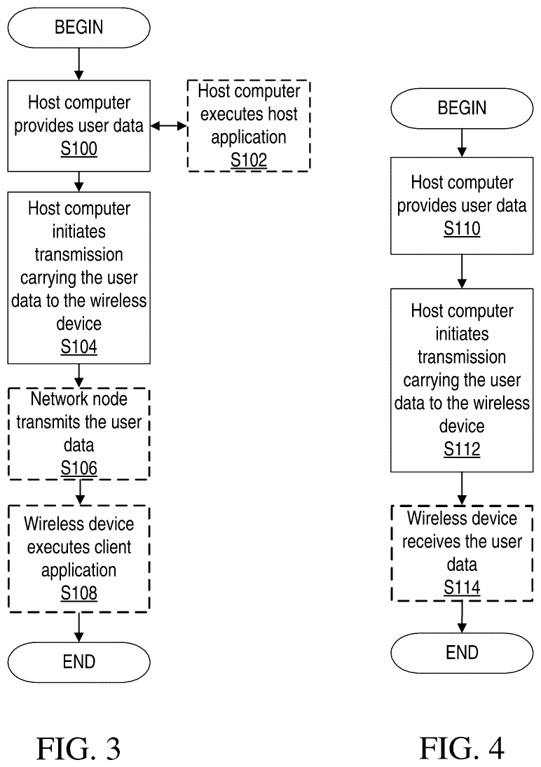

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

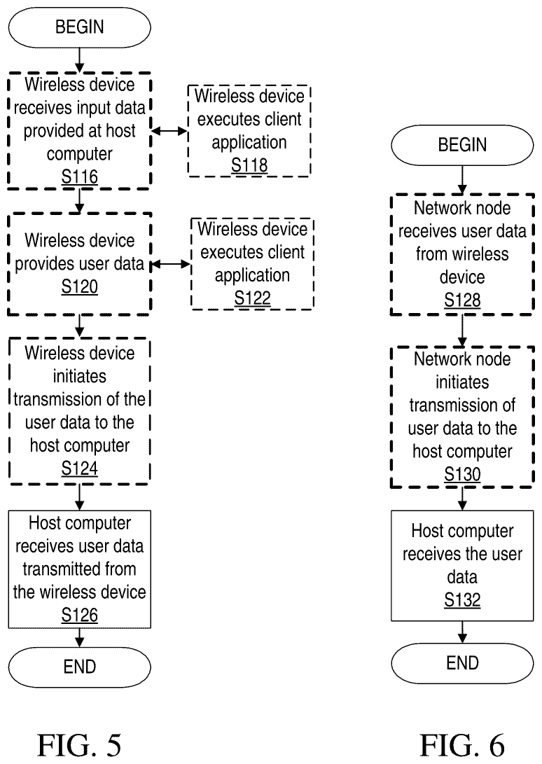

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

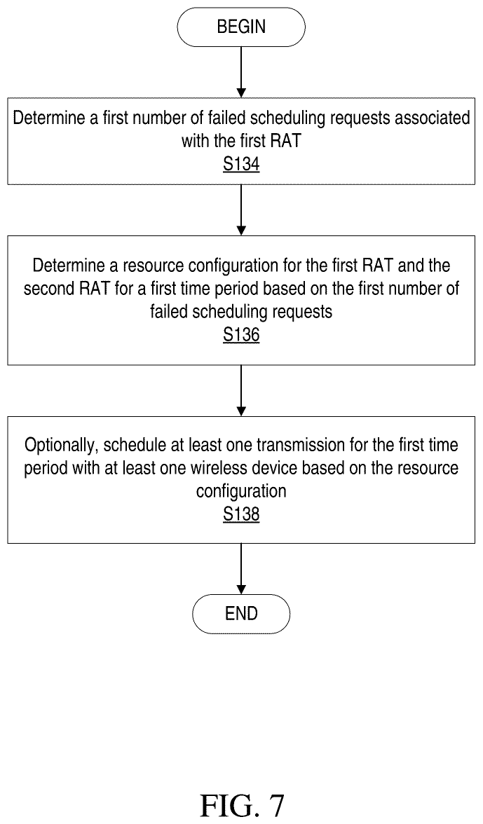

FIG. 7 is a flowchart of an example process in a network node 16 for adaptive CFI determination in dynamic spectrum sharing. One or more blocks described herein may be performed by one or more elements of network node 16 such as by one or more of processing circuitry 68 (including the Network Node Arbitrator unit 32), processor 70, radio interface 62 and/or communication interface 60. Network node 16 is configured to determine (Block S134) a first number of failed scheduling requests associated with the first RAT, to determine (Block S136) a resource configuration for the first RAT and the second RAT for a first time period based on the first number of failed scheduling requests, and, optionally, to schedule (Block S138) at least one transmission for the first time period with at least one wireless device 22 based on the resource configuration.

In some embodiments, the determining of the resource configuration for the first RAT and the second RAT for the first time period is further based on first RAT traffic demands and second RAT traffic demands. In some embodiments, the determining of the resource configuration for the first RAT and the second RAT for the first time period includes computing a cost function, where the cost function is computed based on at least one of the first number of failed scheduling requests associated with the first RAT, at least one weighting factor associated with at least one corresponding failed scheduled request of the first number of failed scheduling requests associated with the first RAT, and a previous computed cost associated with a previous time period prior to the first time period. In some embodiments, the at least one weighting factor is determined based on at least one of an amount of elapsed time since the at least one corresponding failed scheduling request occurred, traffic characteristics associated with at least one of the first RAT and the second RAT, a priority associated with the at least one corresponding failed scheduling request, a burstiness characteristic of the at least one corresponding failed scheduling request, and a stability value associated with the at least one corresponding failed scheduling request.

In some embodiments, the resource configuration is selected from a set of available resource configurations, and the set of available resource configurations is determined based on whether the output of the cost function is above a threshold value. In some embodiments, the threshold value is determined based on traffic characteristics associated with at least one of the first RAT and the second RAT. In some embodiments, the network node 16 is further configured to update the at least one weighting factor for computing the cost function for a subsequent time period to the first time period. In some embodiments, the resource configuration corresponds to at least one of a control format indicator, CFI, Max configuration, and a symbol configuration. In some embodiments, the network node 16 is a distributed unit, DU, configured to communicate with a radio unit in communication with the at least one wireless device 22, the scheduling of the at least one transmission for the first time period including configuring the radio unit with the CFI Max configuration. In some embodiments, the first RAT is a legacy RAT, and the second RAT is a non-legacy RAT.

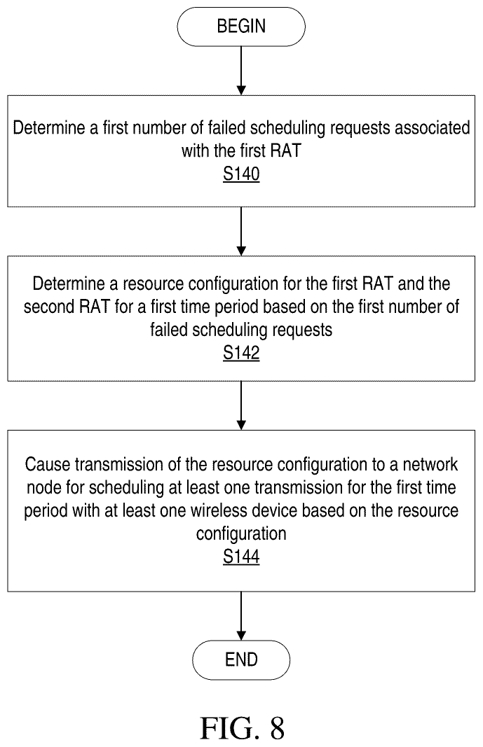

FIG. 8 is a flowchart of an example process in an orchestrator node 31 (e.g., a cloud-based orchestrator node 31, a DU orchestrator node 31, etc.) according to some embodiments of the present disclosure for adaptive CFI determination in dynamic spectrum sharing. One or more blocks described herein may be performed by one or more elements of orchestrator node 31 such as by one or more of processing circuitry 77 (including the Orchestrator Arbitrator unit 34), processor 78, and/or communication interface 76. The orchestrator node 31 is configured to determine (Block S140) a first number of failed scheduling requests associated with the first RAT, determine (Block S142) a resource configuration for the first RAT and the second RAT for a first time period based on the first number of failed scheduling requests, and cause transmission (Block S134) of the resource configuration to a network node 16 for scheduling at least one transmission for the first time period with at least one wireless device 22 based on the resource configuration.

In some embodiments, the determining of the resource configuration for the first RAT and the second RAT for the first time period is further based on first RAT traffic demands and second RAT traffic demands. In some embodiments, the determining of the resource configuration for the first RAT and the second RAT for the first time period includes computing a cost function, where the cost function is computed based on at least one of the first number of failed scheduling requests associated with the first RAT, at least one weighting factor associated with at least one corresponding failed scheduled request of the first number of failed scheduling requests associated with the first RAT, and a previous computed cost associated with a previous time period prior to the first time period. In some embodiments, the at least one weighting factor is determined based on at least one of an amount of elapsed time since the at least one corresponding failed scheduling request occurred, traffic characteristics associated with at least one of the first RAT and the second RAT, a priority associated with the at least one corresponding failed scheduling request, a burstiness characteristic of the at least one corresponding failed scheduling request, and a stability value associated with the at least one corresponding failed scheduling request.

In some embodiments, the resource configuration is selected from a set of available resource configurations, and the set of available resource configurations is determined based on whether the output of the cost function is above a threshold value. In some embodiments, the threshold value is determined based on traffic characteristics associated with at least one of the first RAT and the second RAT. In some embodiments, the orchestrator node is further configured to update the at least one weighting factor for computing the cost function for a subsequent time period to the first time period. In some embodiments, the resource configuration corresponds to at least one of a control format indicator, CFI, Max configuration, and a symbol configuration. In some embodiments, the network node 16 is a distributed unit, DU, configured to communicate with a radio unit in communication with the at least one wireless device 22, the scheduling of the at least one transmission for the first time period including configuring the radio unit with the CFI Max configuration. In some embodiments, the first RAT is a legacy RAT, where the second RAT is a non-legacy RAT.

Having described the general process flow of arrangements of the disclosure and having provided examples of hardware and software arrangements for implementing the processes and functions of the disclosure, the sections below provide details and examples of arrangements for adaptive CFI determination in dynamic spectrum sharing.

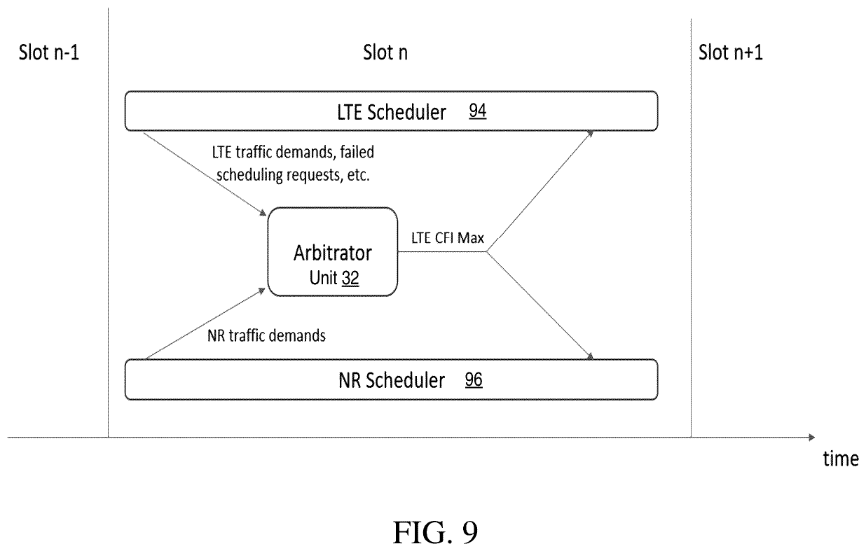

FIG. 9 is a timing diagram which depicts an example adaptive CFI determination in dynamic spectrum sharing according to some embodiments of the present disclosure. During slot n, the LTE scheduler 94 (e.g., implemented in software 74 and/or processing circuitry 68 of network node(s) 16 and/or implemented in software 80 and/or processing circuitry 77 of orchestrator node 31) and the NR Scheduler 96 (e.g., implemented in software 74 and/or processing circuitry 68 of network node(s) 16 and/or implemented in software 80 and/or processing circuitry 77 of orchestrator node 31) communicate with an Network Node Arbitrator unit 32 (and/or Orchestrator Arbitrator unit 34, not shown in FIG. 9). The LTE Scheduler 94 communicates LTE traffic demands, failed scheduling requests, etc. to the Network Node Arbitrator unit 32 (and/or Orchestrator Arbitrator unit 34). The NR scheduler 96 transmits NR traffic demands to the Network Node Arbitrator unit 32 (and/or Orchestrator Arbitrator unit 34). The Network Node Arbitrator unit 32 (and/or Orchestrator Arbitrator unit 34) determines an LTE FCI Max value and communicates this to the LTE Scheduler 94 and/or NR scheduler 96.

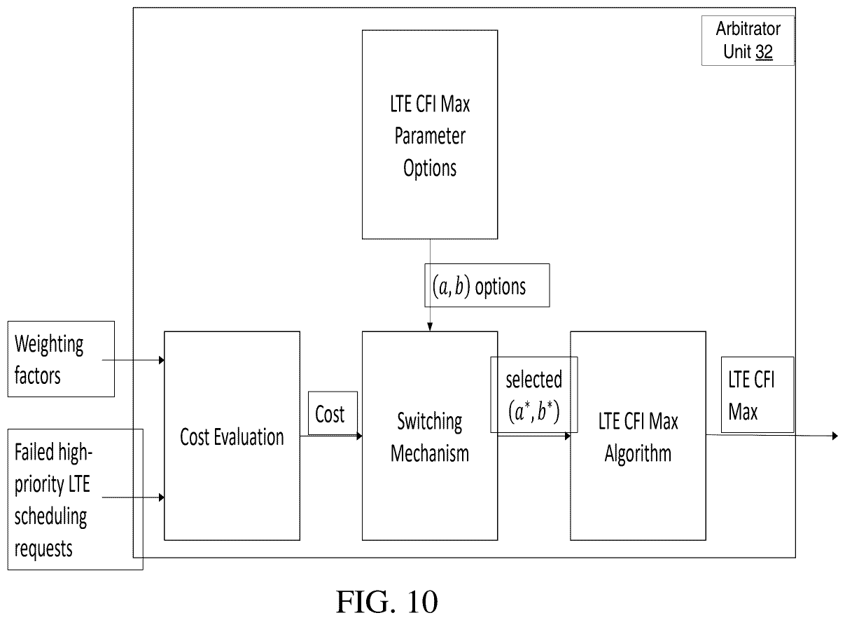

FIG. 10 is a block diagram which depicts an example Network Node Arbitrator unit 32 (and/or Orchestrator Arbitrator unit 34) algorithm according to some embodiments of the present disclosure. In some embodiments, a cost function may evaluate the performance of high-priority LTE scheduling requests.

The cost function may be employed (e.g., by Network Node Arbitrator unit 32 and/or Orchestrator Arbitrator unit 34) to assist the determination of LTE CFI Max, which in turn determines the number of OFDM symbols used in NR PDSCH.

For example, in some embodiments, if the computed cost is less than a target threshold (i.e., the performance of high-priority LTE traffic is satisfactory), LTE CFI Max=1 is enabled, thereby increasing NR throughput performance. If the computed cost is equal to or above a target threshold (i.e., the performance of high-priority LTE traffic is worse than the target), LTE CFI Max=1 is disabled and a legacy LTE CFI Max algorithm may be employed.

The cost function (e.g., calculated by Network Node Arbitrator unit 32 and/or Orchestrator Arbitrator unit 34) may consider (but is not limited to) the following factors:
Failed scheduling requests of high-priority LTE traffic: the higher the number of failed scheduling requests of high-priority LTE traffic, the higher the cost.
Weighting factors on recent failed scheduling requests of high-priority LTE traffic and past failed scheduling requests of high-priority LTE traffic.

An example cost function (e.g., calculated by Network Node Arbitrator unit 32 and/or Orchestrator Arbitrator unit 34) is an exponentially weighted average of the number of failed high-priority LTE scheduling requests, which can be shown as follows:

$$Cost ( t + 1 ) = alpha * nrofFailedHighPrioLteSrs ( t ) + ( 1 - alpha ) * Cost ( t )$$

Where
nrofFailedHighPrioLteSrs(t) is the number of failed high-priority LTE scheduling requests at time t
Cost(t) is the cost at time t
alpha is a weighting factor, indicating how important the recent failed LTE scheduling requests relative to past failed LTE scheduling requests.

Secondly, LTE CFI Max parameter options are considered/evaluated (e.g., by Network Node Arbitrator unit 32 and/or Orchestrator Arbitrator unit 34). Denoting f as the LTE CFI Max determination algorithm:

$$lteCfi Max = f ( a , b )$$

where a and b are input parameters that govern the value of LTE CFI Max computed by the algorithm f.

In some embodiments, (a, b)=(2, 3), where the minimum value of LTE CFI Max is 2 and the maximum value of LTE CFI Max is 3.

In an adaptive algorithm according to some embodiments of the present disclosure, by comparison, there may be multiple LTE CFI Max parameter options of (a, b). For instance, (a, b)={(2, 3), (1, 2)}.

An LTE CFI Max parameter option may be determined/computed/selected (e.g., by Network Node Arbitrator unit 32 and/or Orchestrator Arbitrator unit 34) based on a selection mechanism (described below), and the parameter option may then be passed to the LTE CFI Max algorithm. The LTE CFI Max algorithm may then output the LTE CFI Max value bounded by a and b, and the LTE CFI Max value may be communicated (e.g., by Network Node Arbitrator unit 32 and/or Orchestrator Arbitrator unit 34) to LTE scheduler 94 and/or NR scheduler 96.

In some embodiments, Network Node Arbitrator unit 32 and/or Orchestrator Arbitrator unit 34 may utilize an LTE CFI Max Parameter Selection mechanism among different LTE CFI Max parameter options.

For instance, with (a, b)={(2, 3), (1, 2)}, there are two parameter options.

One embodiment for the parameter selection between (2,3) and (1,2) can be based on the cost function evaluation against a user-defined threshold.

For instance, if cost (t)<Threshold, change (a, b) to (1,2); otherwise, change (a, b) to (2,3), where the threshold is a tunable user-defined input parameter.

Another embodiment for the parameter selection between (2,3) and (1,2) can be based on both the cost function and the trajectory of the costs over time.

For instance, if cost (t)<Threshold or if the rate of improvement >10%, change (a, b) to (1,2); otherwise, change (a, b) to (2,3).

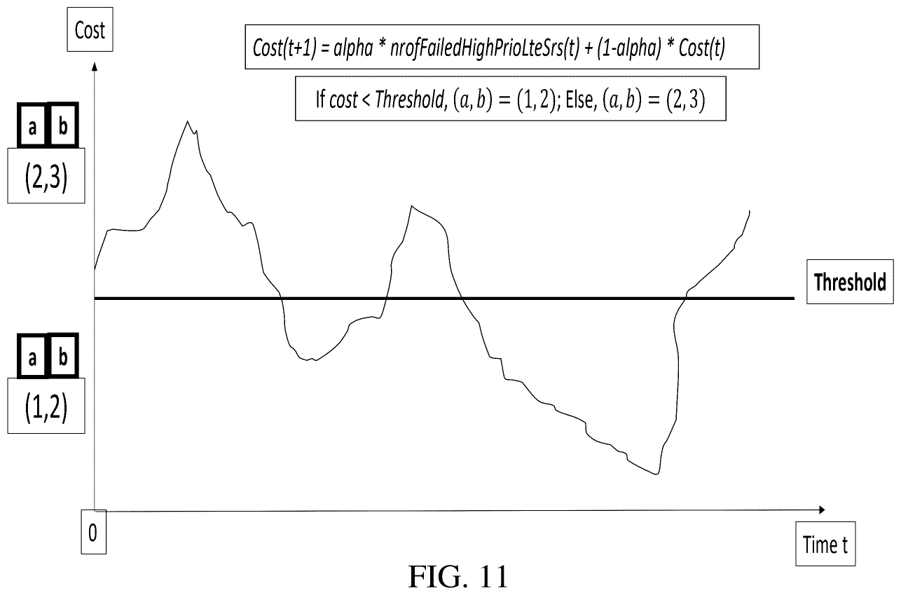

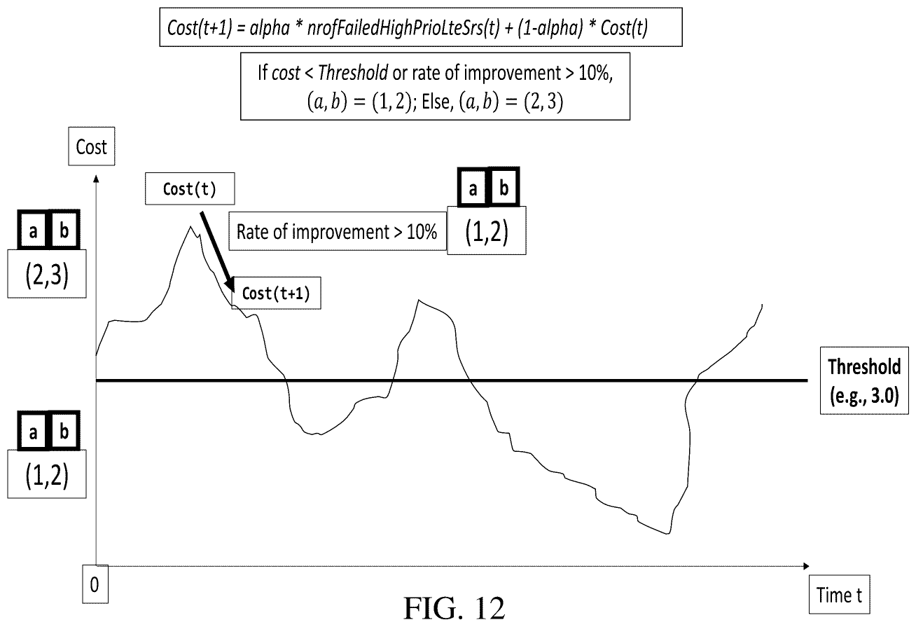

FIG. 11 and FIG. 12 are timing diagrams which depicts example Network Node Arbitrator unit 32 (and/or Orchestrator Arbitrator unit 34) algorithm outputs over time according to some embodiments of the present disclosure.

In the example depicted in FIG. 11, the algorithm (e.g., implemented by Network Node Arbitrator unit 32 and/or Orchestrator Arbitrator unit 34) is defined according to:

Cost(t+1) = alpha * nrofFailedHighPrioLteSrs(t) + (1-alpha) * Cost(t)
If cost < Threshold, (a, b) = (1, 2); Else, (a, b) = (2, 3)

Referring to FIG. 11, when the cost is below a target threshold, the performance of high-priority LTE traffic satisfactory, and thus the system (e.g., Network Node Arbitrator unit 32 and/or Orchestrator Arbitrator unit 34) may allocate more symbols to NR PDSCH to improve NR throughput (e.g., without sacrificing high-priority LTE traffic performance). When the cost exceeds a target threshold, the performance of high-priority LTE traffic is unsatisfactory, and the system (e.g., Network Node Arbitrator unit 32 and/or Orchestrator Arbitrator unit 34) may allocate more symbols to LTE PDCCH, which is governed by a higher value of LTE CFI Max, accordingly.

In the example depicted in FIG. 12, the algorithm (e.g., implemented by Network Node Arbitrator unit 32 and/or Orchestrator Arbitrator unit 34) is defined according to:

```
  Cost(t+1) = alpha * nrofFailedHighPrioLteSrs(t) + (1-alpha) * Cost(t)
  If cost < Threshold or rate of improvement > 10%, (a, b) = (1, 2); Else,
(a, b) = (2, 3)
```

Referring to FIG. 12, in one example, when the cost is below a target threshold or the rate of improvement exceeds 10%, meaning that the performance of high-priority LTE traffic is or will soon be satisfactory (e.g., predicted to be satisfactory based on rate of improvement), the system (e.g., by Network Node Arbitrator unit 32 and/or Orchestrator Arbitrator unit 34) may allocate more symbols to NR PDSCH, improving NR throughput.

In this example, When the cost exceeds a target threshold and the rate of improvement is less than 10%, the system (e.g., by Network Node Arbitrator unit 32 and/or Orchestrator Arbitrator unit 34) may allocate more symbols to LTE PDCCH, which is governed by a higher value of LTE CFI Max.

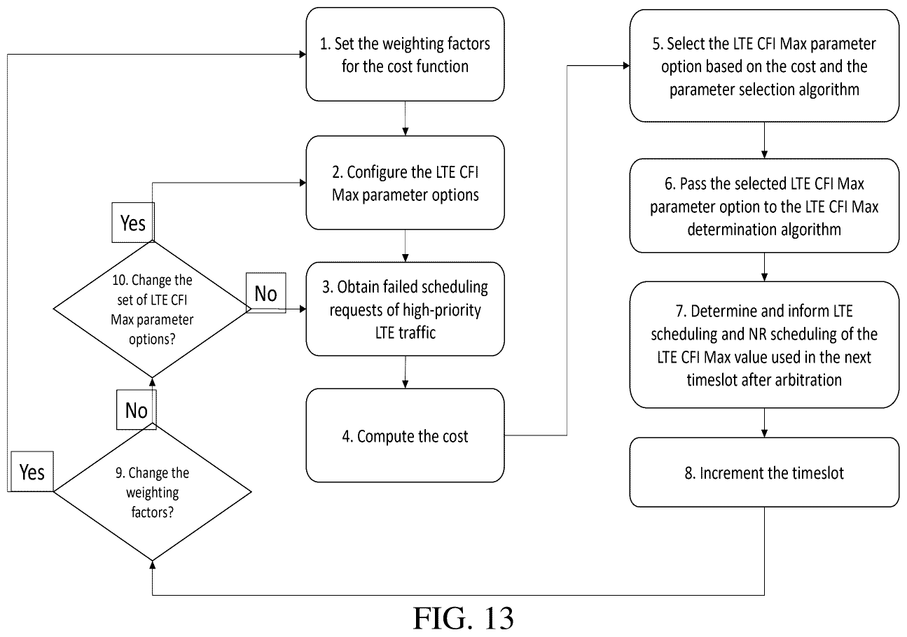

FIG. 13 is a flowchart which depicts an example adaptive CFI determination in dynamic spectrum sharing (e.g., as implemented by Network Node Arbitrator unit 32 and/or Orchestrator Arbitrator unit 34) according to some embodiments of the present disclosure. In Step 1, the weighting factors are set for the cost function (e.g., by Network Node Arbitrator unit 32 and/or Orchestrator Arbitrator unit 34). In Step 2, the LTE CFI Max parameter options are configured (e.g., by Network Node Arbitrator unit 32 and/or Orchestrator Arbitrator unit 34). In Step 3, the failed scheduling requests of LTE traffic (e.g., high-priority LTE traffic) are obtained (e.g., via LTE scheduler 94). In Step 4, the cost is computed (e.g., as described in any one of the examples above). In Step 5, the LTE CFI Max parameter option is selected (e.g., by Network Node Arbitrator unit 32 and/or Orchestrator Arbitrator unit 34) based on the cost and the parameter selection algorithm. In Step 6, the LTE CFI Max parameter option is passed to the LTE CFI Max determination algorithm (e.g., within Network Node Arbitrator unit 32 and/or Orchestrator Arbitrator unit 34). In Step 7, the LTE CFI Max value used in the next timeslot after arbitration (e.g., slot n+1) is determined (e.g., by Network Node Arbitrator unit 32 and/or Orchestrator Arbitrator unit 34) and communicated to the LTE scheduler 94 and/or NR scheduler 96. In Step 8, the timeslot is incremented (e.g., by Network Node Arbitrator unit 32 and/or Orchestrator Arbitrator unit 34). In Step 9, the algorithm (e.g., implemented by Network Node Arbitrator unit 32 and/or Orchestrator Arbitrator unit 34) determines whether to change the weighting factors (as described below in greater detail). If the outcome of Step 9 is “Yes”, then the flow proceeds back to Step 1, and the process repeats (e.g., in Network Node Arbitrator unit 32 and/or Orchestrator Arbitrator unit 34) for subsequent time slot(s). If the outcome of Step 9 is “No”, then the flow proceeds to Step 10, and the algorithm (e.g., implemented by Network Node Arbitrator unit 32 and/or Orchestrator Arbitrator unit 34) determines whether to change the set of LTE CFI Max parameter options. If the outcome of Step 10 is “Yes’, then the flow proceeds to Step 2, and the process repeats from Step 2 onward. If the outcome of Step 10 is “No”, then the flow proceeds to Step 3, and the process repeats from Step 3 onward.

In some embodiments, traffic characteristics in different wireless networks are expected to be different, and such differences may be taken into account, e.g., by Network Node Arbitrator unit 32 and/or Orchestrator Arbitrator unit 34, when performing one or more of the above calculations described, e.g., with respect to FIG. 13. For example:
High-priority LTE traffic in Network A can be very bursty while that in Network B can be quasi-static.
Thus, the weighting factor for the recently failed scheduling requests may be set (e.g., by Network Node Arbitrator unit 32 and/or Orchestrator Arbitrator unit 34) to a larger value for bursty high-priority LTE traffic while a smaller value should be used (e.g., by Network Node Arbitrator unit 32 and/or Orchestrator Arbitrator unit 34) for the recently failed scheduling requests if high-priority LTE traffic is relatively stable.

The threshold(s) used (e.g., by Network Node Arbitrator unit 32 and/or Orchestrator Arbitrator unit 34) in the LTE CFI Max parameter option selection algorithm may also be a function of traffic characteristics observed in the field, in some embodiments. For example, historical traffic characteristics may be used (e.g., by Network Node Arbitrator unit 32 and/or Orchestrator Arbitrator unit 34) to modify one or more of the calculations described, e.g., with respect to FIG. 13.

In some embodiments, only high-priority traffic LTE is considered, in other words, information regarding non-high-priority LTE traffic, such as failed requests associate with non-high-priority LTE traffic, is not considered by the LTE CFI Max determination calculation (e.g., by Network Node Arbitrator unit 32 and/or Orchestrator Arbitrator unit 34). In other embodiments, all (or some subset) of LTE traffic is considered (e.g., by Network Node Arbitrator unit 32 and/or Orchestrator Arbitrator unit 34), such that higher priority LTE traffic (and failed requests associated therewith) may be weighted more heavily than lower priority LTE traffic. Priority levels associated with (failed) LTE traffic requests priority may be indicated (e.g., by LTE scheduler 94), and/or may be determined (e.g., by Network Node Arbitrator unit 32 and/or Orchestrator Arbitrator unit 34), such as based on one or more characteristics of the LTE traffic (e.g., quality of service (QoS) requirements associated with the traffic, emergency vs. non-emergency communications associated with the traffic, etc.).

Parameter sweeping and/or optimization may be utilized (e.g., by Network Node Arbitrator unit 32 and/or Orchestrator Arbitrator unit 34) to further improve a performance tradeoff between NR throughput performance and high-priority LTE traffic performance.

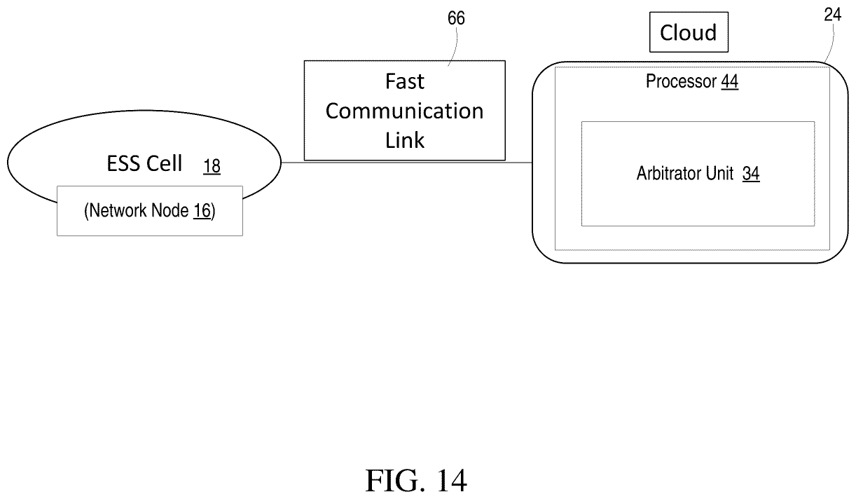

In some embodiments, a cloud-based implementation may be used, as depicted in the architecture shown in FIG. 14, in which a DSS Cell 18 (e.g., served by a network node 16) is in communication with an orchestrator node 31, which may be cloud-based (e.g., a cloud-based server), via a connection 66 (which may be, e.g., a “fast” connection, such as a high-speed wired connection). The orchestrator node 31 includes a processor 78 which includes an Orchestrator Arbitrator unit 34 which implements an adaptive LTE CFI Max determination algorithm, as described herein.

In some embodiments, radio resource arbitration in dynamic spectrum sharing may be performed per each timeslot in baseband units (e.g., processing circuitry 68 of network node(s) 16), and/or may be performed according to other timescales. Due to tight delay requirements in some systems, performing resource arbitration outside the baseband units (e.g., in a cloud-based server such as an orchestrator node 31) may pose a challenge.

In some embodiments of the present disclosure, implementing an adaptive LTE CFI Max determination algorithm inside a Network Node Arbitrator unit 32 and/or Orchestrator Arbitrator unit 34 may require a slight increase in computational complexity in resource arbitration, but such algorithm(s) may not require such computational complexity as to become a bottleneck in a cloud-based implementation.

A DSS Cell 18 (and/or network node 16) may send the following information to the orchestrator node 31 of interest (e.g., residing in the cloud):
a) Traffic demands; and/or
b) Failed scheduling requests of LTE traffic (e.g., high-priority LTE traffic).
c) After receiving required inputs, the orchestrator node 31 (e.g., Orchestrator Arbitrator unit 34 and/or processing circuitry 77) may:
d) Compute the cost function, as described herein;
e) Configure the set of LTE CFI Max parameter options, as described herein;
f) Select an LTE CFI Max parameter option, as described herein;
g) Execute an LTE CFI Max determination algorithm; and/or
h) Send an LTE CFI Max value back to the DSS Cell 18/network node 16.

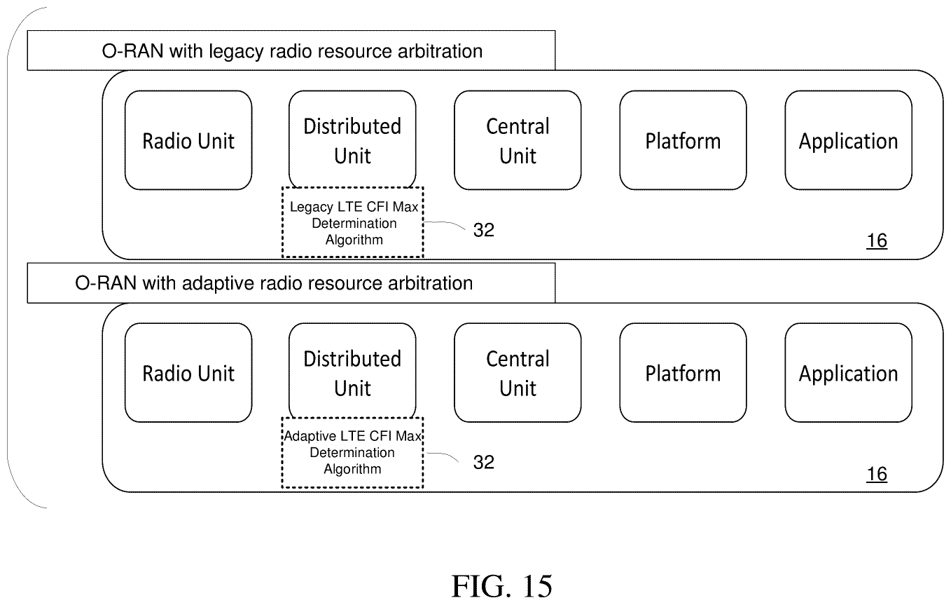

FIG. 15 depicts an example O-RAN implementation according to some embodiments of the present disclosure, comparing a legacy radio resource arbitration to an adaptive radio resource arbitration according to embodiments of the present disclosure.

In some Open Radio Access Network (O-RAN) architectures, a Network Node Arbitrator unit 32 (and/or Orchestrator Arbitrator unit 34) for DSS typically resides in distributed units (DUs)/network nodes 16/orchestrator nodes 31/etc., since this belongs to MAC-layer resource allocations.

In embodiments of the present disclosure, the Network Node Arbitrator unit 32 and/or Orchestrator Arbitrator unit 34 may be incorporated in a DU in network node 16 (and/or in cloud-based server, e.g., orchestrator node 31, not shown in FIG. 15) as part of the O-RAN implementation, which in some embodiments, may be done without altering any existing radio unit, central unit, platform, application, etc.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| | |
|---|---|
| DSS | Dynamic Spectrum Sharing |
| CFI | Control Format Indicator |
| OFDM | Orthogonal Frequency Division Multiplexing |
| PDCCH | Physical Downlink Control Channel |
| PDSCH | Physical Downlink Shared Channel |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured for dynamic spectrum sharing of a first radio access technology (RAT) and a second RAT, the network node comprising processing circuitry configured to:
determine a first number of failed scheduling requests associated with the first RAT;
determine a resource configuration for the first RAT and the second RAT for a first time period based on the first number of failed scheduling requests; and
schedule at least one transmission for the first time period with at least one wireless device based on the resource configuration.

2-10. (canceled)

11. A method implemented in a network node, the method comprising:
determining a first number of failed scheduling requests associated with a first radio access technology (RAT);
determining a resource configuration for the first RAT and a second RAT for a first time period based on the first number of failed scheduling requests; and
scheduling at least one transmission for the first time period with at least one wireless device based on the resource configuration.

12. The method of claim 11, wherein the determining of the resource configuration for the first RAT and the second RAT for the first time period is further based on first RAT traffic demands and second RAT traffic demands.

13. The method of claim 12, wherein the determining of the resource configuration for the first RAT and the second RAT for the first time period includes computing a cost function, the cost function being computed based on at least one of:
the first number of failed scheduling requests associated with the first RAT;
at least one weighting factor associated with at least one corresponding failed scheduled request of the first number of failed scheduling requests associated with the first RAT; and
a previous computed cost associated with a previous time period prior to the first time period.

14. The method of claim 13, wherein the at least one weighting factor is determined based on at least one of:
an amount of elapsed time since the at least one corresponding failed scheduling request occurred;
traffic characteristics associated with at least one of the first RAT and the second RAT;
a priority associated with the at least one corresponding failed scheduling request;
a burstiness characteristic of the at least one corresponding failed scheduling request; and
a stability value associated with the at least one corresponding failed scheduling request.

15. The method of claim 13, wherein the resource configuration is selected from a set of available resource configurations; and
the set of available resource configurations being determined based on whether the output of the cost function is above a threshold value.

16. The method of claim 15, wherein the threshold value is determined based on traffic characteristics associated with at least one of the first RAT and the second RAT.

17. The method of claim 13, further comprising updating the at least one weighting factor for computing the cost function for a subsequent time period to the first time period.

18. The method of claim 13, wherein the resource configuration corresponds to at least one of:
a control format indicator, CFI, Max configuration; and
a symbol configuration.

19. The method of claim 18, wherein the network node is a distributed unit, DU, configured to communicate with a radio unit in communication with the at least one wireless device, the scheduling of the at least one transmission for the first time period including configuring the radio unit with the CFI Max configuration.

20. The method of claim 11, wherein the first RAT is a legacy RAT, the second RAT being a non-legacy RAT.

21-30. (canceled)

31. A method implemented in an orchestrator node configured for dynamic spectrum sharing of a first radio access technology (RAT) and a second RAT, the method comprising:
determining a first number of failed scheduling requests associated with the first RAT;
determining a resource configuration for the first RAT and the second RAT for a first time period based on the first number of failed scheduling requests; and
causing transmission of the resource configuration to a network node for scheduling at least one transmission for the first time period with at least one wireless device based on the resource configuration.

32. The method of claim 31, wherein the determining of the resource configuration for the first RAT and the second RAT for the first time period is further based on first RAT traffic demands and second RAT traffic demands.

33. The method of claim 32, wherein the determining of the resource configuration for the first RAT and the second RAT for the first time period includes computing a cost function, the cost function being computed based on at least one of:
the first number of failed scheduling requests associated with the first RAT;
at least one weighting factor associated with at least one corresponding failed scheduled request of the first number of failed scheduling requests associated with the first RAT; and
a previous computed cost associated with a previous time period prior to the first time period.

34. The method of claim 33, wherein the at least one weighting factor is determined based on at least one of:
an amount of elapsed time since the at least one corresponding failed scheduling request occurred;
traffic characteristics associated with at least one of the first RAT and the second RAT;
a priority associated with the at least one corresponding failed scheduling request;
a burstiness characteristic of the at least one corresponding failed scheduling request; and
a stability value associated with the at least one corresponding failed scheduling request.

35. The method of claim 33, wherein the resource configuration is selected from a set of available resource configurations; and
the set of available resource configurations being determined based on whether the output of the cost function is above a threshold value.

36. The method of claim 35, wherein the threshold value is determined based on traffic characteristics associated with at least one of the first RAT and the second RAT.

37. The method of claim 33, further comprising updating the at least one weighting factor for computing the cost function for a subsequent time period to the first time period.

38. The method of claim 33, wherein the resource configuration corresponds to at least one of:
a control format indicator, CFI, Max configuration; and
a symbol configuration.

39. The method of claim 38, wherein the network node is a distributed unit, DU, configured to communicate with a radio unit in communication with the at least one wireless device, the scheduling of the at least one transmission for the first time period including configuring the radio unit with the CFI Max configuration.

40. (canceled)
